(19) United States
(12) Patent Application Publication
(10) Pub. No.: US 2010/0216102 A1
(43) Pub. Date: Aug. 26, 2010

(54) Bio-essence energy packet/card

(76) Inventor: Jeff D. Allen, Boise, ID (US)

Correspondence Address: Jeff Allen, 1877 Peppery Pl., Boise, ID, 83709, US

(21) Appl. No.: 12/378,771

(22) Filed: Feb. 20, 2009

(51) Int. Cl. G09B 19/00

(52) U.S. Cl. 434/236

(57) ABSTRACT

A method whereby information, positive statements or affirmations are repeated 1000's of times and printed repeatedly on sheets of standard printing material using very small font. Each individual sheet is layered into a stack to form a packet of condensed and combined statements of positive influencing messages to improve the well being of the holder. The packets can be made using many different methods and designs disclosed in the following.

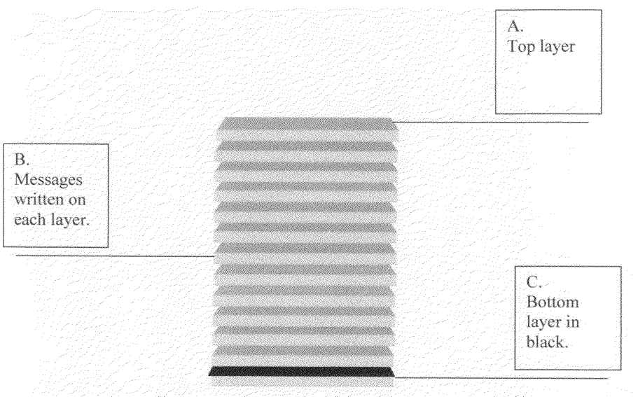

### FIELD OF THE INVENTION

The present invention is an apparatus herein called a Bio-Essence Energy Packet/Card that is used to improve positive mental attitude through a concentration of repeated affirmations written 1000's of times. This is accomplished by printing repeated affirmations many times in small font size on any material, preferably paper, and then stacking many layers of the repeated affirmations to form the Bio-Essence Energy Packet/Card.

The primary purpose of the Bio-Essence Energy Packet/Card is to provide a sense of well being in the mind and body of the user by neutralizing and/or releasing existing negative thoughts or bio-essence energies and stimulating and/or realigning beneficial thoughts or bio-essence energies.

It is of common practice to use positive mental intention or Bio-Essence Energy while implementing a healing touch, massage therapy, and many other modalities whereby a care giver envisions good energy or Bio-Essence energy transferring to someone or something by physically touching at the point of interest for the specific purpose of improving a predetermined healing outcome.

Intentionally having the desire to improve ones personal bio-essence energy and holding the Packet/Card simultaneously creates an added improvement stated by the individual. The user commonly has an improved state of well being with the use of the Bio-Essence Energy Packet/Card.

It has further been found to be beneficial when used in the practice of massage therapy, acupressure treatment, acupuncture treatment and the like where a practitioner is using the Bio-Essence Energy Packet/Card to improve the individuals Bio-Essence energy by applying the Packet/Card physically on the person to gain an improved state of well being.

It has also been found that the Bio-Essence Energy Packet/Card can be used in many other ways not described here in.

### BACKGROUND AND SUMMARY OF THE INVENTION

The practice of using words, affirmations, symbols and pictures to create a positive mental attitude has been used for 1000's of years. The personal development industry has implemented this practice and is presently teaching the use of saying affirmations repeatedly to ones self to overcome negative thinking and replace it with a positive mental attitude.

Masaru Emoto has established that through the use of scientific experiments that energy can be transferred into water by writing a word on a water container. In his experiment he wrote the word love on a filled water container and then by freezing the water in the container a very beautiful crystal is viewed in the ice using a microscope and when writing the word hate no crystal is formed. Masaru Emoto has established that energy is transferred when a message or affirmation is written down.

This new method to improve a state of well being uses both methods. The first is to repeat affirmations 1000's of times and the second is to write affirmations down a multiple of times to give them energy.

This new device is constructed by layering or stacking a series of printed affirmations with each affirmation printed multiple times per layer. The messages create an intention of well being or transformation written in a specific ways to improve a predetermined outcome. The messages that are written on each layer of the Packet/Card can be written using pictures, symbols, numbers, letters or words of specific meanings. The messages are written very small allowing the statement to be repeated 1000's of times on each layer in the layered stack.

The method of making a Bio-Essence Energy Packet/Card is very specific as to the order of stacking the layers of the affirmations to achieve the perceived effectiveness.

Research completed with those that are familiar with healing energy and have used the Bio-Essence Energy Packet/Card in their process have found an increased flow of Bio-Essence Energy and an improved sense of well being.

### DETAILED DESCRIPTION

Embodiment Bio-Essence Energy Packet/Card

The Packet/Card is constructed by layering or stacking layers of printed on material that has been cut in similar to identical size. The multiple layers are glued together forming a Packet/Card several times thicker than the individual layers separately. The Packet/Card is then covered with a water and wear resistant material.

The number of layers used is determined by the specific affirmation or intention required and can be put together in a vast range of affirmations and layers to make the intention of the Packet/Card unique.

Each layer is printed for specific results. The affirmations or messages on each layer are written using words, pictures, symbols, letters or numbers. The statements or messages are printed with the smallest font possible to provide the maximum amount of repeated messages to increase effectiveness.

The bottom layer is printed in solid black or a black material is used and the top layer has the overall intention of the Packet/Card printed on it. It has also been found that using different colors of ink and material to be printed on can effectively change intention of the Packet/Card and the desired outcome.

### DESCRIPTION OF DRAWINGS

Embodiment Bio-Essence Energy Packet/Card

The new device is constructed by using numbers, letters, symbols, pictures, and words to create a message. The message is then written many times on each of the layers stacked in a specific sequence one on top of the next until the intended message has been repeated enough to optimize its results.

The predetermined message is most commonly written and then reduced in size using a standard computer and printer, whereby the message can be printed many times on each layer. The bottom layer (C) is printed black or black material is used and cut into the predetermined size. A thin coat of adhesive can be used by placing on the top side of the bottom layer (C).

The second layer (B) or the first one above the bottom layer (C) is the first layer having repeated printed affirmations on it and is then cut into the same or similar size to match layer (C) dimensions. Layer (B) is then placed on the top side of layer (C). If adhesive is being used, (C) will be adhering to (B).

The process is then repeated by placing the next (B) layer on top of the last (B) layer until the message is complete. If adhesive is being used all the layers will be glued together forming the final message.

The final layer (A) is cut into the same or similar predetermined size as (B) after printing the written message or affirmation using a font that is large enough to read.

The top layer (A) has the final message that describes the intended purpose of the Packet/Card and is then adhered if necessary to the top (B) layer completing the stack or Packet/Card.

The Packet/Card has now been assembled by stacking several layers of affirmations or messages together to form the Bio-Essence Energy Packet/Card. The Packet/Card is then covered with any treatment that will provide a plasticized or protective coating to promote its longevity and functionality in high use conditions.

1. A Device wherein messages or affirmations are repeated many times and used by the holder to improve the well-being of humans as well as animals. This is accomplished by stacking many printed layers of repeated messages or affirmations to form a Bio-Essence Energy Packet/Card.
i. a method wherein messages or affirmations are repeatedly printed on one or both sides of any material, with paper being the preferred material.
ii. a method wherein the use of small print is preferred allowing the ability to repeat the message or affirmations as many times as possible per layer.
iii. a method wherein many layers of printed messages or affirmations are stacked, layered or folded together to multiply the number of repeated messages or affirmations in a smaller area.

2. The device of claim 1, wherein the bottom layer is black in color or colored black.

3. The device of claim 1, wherein the top layer also has the intended message or affirmation of the Packet/Card written on it.

4. The device of claim 1, wherein different colors of layers can be used.

5. The device of claim 1, wherein different colors of ink can be used.

6. The device of claim 1, wherein numbers are used.

7. The device of claim 1, wherein letters are used.

8. The device of claim 1, wherein pictures and symbols are used.

9. The device of claim 1, wherein the Packet/Card is cut to form any size or shape, with the preferred size to be small enough to hold comfortable in the palm of ones hand. (ie round, star)

10. The device of claim 1, wherein the multiple Packet/Cards can be stacked to form a larger Packet/Card.
